(19) United States
(12) Patent Application Publication
(10) Pub. No.: US 2007/0202858 A1
(43) Pub. Date: Aug. 30, 2007

(54) Mobile device capable of dynamically adjusting volume and related method

(75) Inventor: Wen-Ting Yu, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: ASUSTeK COMPUTER INC.

(21) Appl. No.: 11/705,760

(22) Filed: Feb. 14, 2007

(30) Foreign Application Priority Data
Feb. 15, 2006 (TW) 095105101

(51) Int. Cl. H04Q 7/38; H04Q 7/22; H04M 3/42

(52) U.S. Cl. 455/414.1

(57) ABSTRACT

A mobile device includes at least a speaker, a range detection unit for detecting a distance between the mobile device and a user, and a volume adjustment unit electrically connected to the range detection unit for dynamically adjusting volume of the speaker according to a result of the range detection unit.

### BACKGROUND OF THE INVENTION

1. Field of the Invention

The present invention provides a mobile device capable of dynamically adjusting volume, and more particularly, a mobile device capable of dynamically adjusting volume according to a range from a user.

2. Description of the Prior Art

Telephones make human communication more and more convenient, and shorten distances between people. Many telephones include handsfree functions, which can perform multi-user communication and decrease hearing loading. However, in the prior art, a handsfree function of a telephone, such as a wireless telephone or a mobile phone, is switched by a keypad. For example, pressing a button for three seconds can switch the handsfree function. Therefore, if a user triggers the handsfree function initially but the user wants to turn off the handsfree function suddenly, the user must press the keypad to turn off the handsfree function. Such actions may not rapidly turn off the handsfree function, and thus cause the user inconvenient. For example, in case that the handsfree function is switched on for multi-user communication by pressing a button for three seconds, the user cannot rapidly stop the handsfree function when talking about personal affairs.

Moreover, when the handsfree function is triggered, the telephone outputs sound with a ring speaker for providing higher power. However, an ideal handsfree function should change volume automatically, meaning that volume is tuned down when the user is at a shorter distance and is turned up when the user is at a longer distance. In the prior art, the user can adjust volume of the telephone only through a volume adjustment button, which is inconvenient.

### SUMMARY OF THE INVENTION

It is therefore a primary objective of the claimed invention to provide a mobile device capable of dynamically adjusting volume and related method.

The present invention discloses a mobile device capable of dynamically adjusting volume. The mobile device includes at least a speaker, a range detection unit for detecting a distance between the mobile device and a user, and a volume adjustment unit electrically connected to the range detection unit for dynamically adjusting volume of the speaker according to a result of the range detection unit.

The present invention discloses a method for dynamically adjusting volume of a mobile device. The method detects a distance between the mobile device and a user, and adjusts the volume of the mobile device dynamically according to the distance between the mobile device and the user.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a block diagram of a telephone capable of dynamically adjusting volume in accordance with an embodiment of the present invention.

FIG. 2 illustrates a flowchart of a process for dynamically adjusting the volume of the telephone shown in FIG. 1.

FIG. 3 illustrates a block diagram of a telephone capable of dynamically adjusting volume in accordance with an embodiment of the present invention.

FIG. 4 illustrates a flowchart of a process for dynamically adjusting the volume of the telephone shown in FIG. 3.

FIG. 5 illustrates a front-view diagram of a mobile phone in accordance with an embodiment of the present invention.

FIG. 6 illustrates a rear-view diagram of the mobile phone shown in FIG. 5.

### DETAILED DESCRIPTION

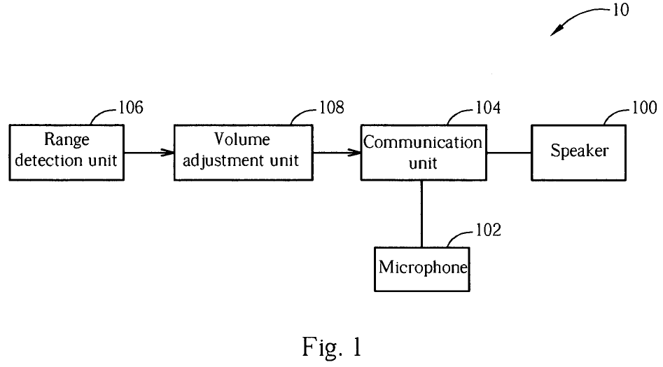

Please refer to FIG. 1, which illustrates a block diagram of a telephone 10 capable of dynamically adjusting volume in accordance with an embodiment of the present invention. The telephone 10 includes a speaker 100, a microphone 102, a communication unit 104, a range detection unit 106, and a volume adjustment unit 108. The speaker 100, the microphone 102, and the range detection unit 106 are installed on a housing (not shown in FIG. 1) of the telephone 10, while the communication unit 104 and the volume adjustment unit 108 are installed inside the housing. The speaker 100, the microphone 102, and the communication unit 104 are utilized for implementing communication functions of the telephone 10. When a user makes a phone call through the telephone 10, the microphone 102 receives and transmits voice signals of the user (with signal processing) to a destination through the communication unit 104. Oppositely, the communication unit 104 can receive signals from the destination and output voice signals (after signal processing) with the speaker 100. The range detection unit 106 measures a distance between the user and the telephone 10, and can be an infrared rangefinder, laser reflection rangefinder, or other devices capable of detecting the distance. According to a result of the range detection unit 106, the volume adjustment unit 108 adjusts volume of the speaker 100 through the communication unit 104. That is, according to the distance between the user and the telephone 100 detected by the range detection unit 106, the volume adjustment unit 108 can decrease the volume of the speaker 100 when the distance is small and increase the volume of the speaker when the distance is large.

Therefore, according to the distance between the user and the telephone 10, the telephone 10 can adjust the volume of the speak 100 automatically. As a result, when the user is at a shorter distance from the telephone 10, the volume of the speaker 100 is tuned down, and when the user is at a longer distance from the telephone 10, the volume of the speaker 100 is turned up. Certainly, functions of the range detection unit 106 and the volume adjustment unit 108 can be enabled after a handsfree function of the telephone 10 is triggered. Other than adjusting the volume of the speaker 100, the present invention can adjust a gain of the microphone 102 according to the distance between the user and the telephone 10. That is, the gain of the microphone 102 is small when the distance is small, and the gain is large when the distance is large.

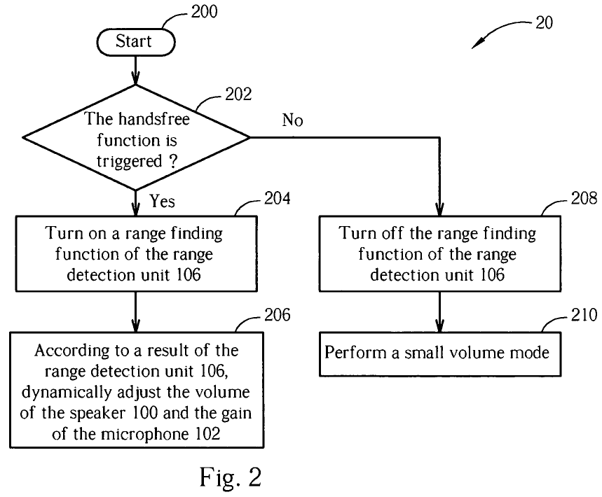

Please refer to FIG. 2, which illustrates a flowchart of a process 20 for dynamically adjusting the volume of the telephone 10. The process 20 includes following steps:
Step 200: a user answers or makes a phone call with the telephone 10.
Step 202: determine whether the handsfree function of the telephone 10 is triggered or not. If yes, go to step 204. If not, go to step 208.
Step 204: turn on a range finding function of the range detection unit 106.
Step 206: dynamically adjust the volume of the speaker 100 and the gain of the microphone 102 according to a result of the range detection unit 106.
Step 208: turn off the range finding function of the range detection unit 106.
Step 210: perform a small volume mode.

Therefore, according to the process 20, when the user answers or makes a phone call with the telephone 10 and the handsfree function is triggered, the telephone 10 can dynamically adjust the volume of the speaker 100 and the gain of the microphone 102 according to a distance between the user and the telephone 10. As a result, the volume of the speaker 100 and the gain of the microphone 102 are tuned down when the distance between the user and the telephone 10 is small, while the volume and the gain are tuned up when the distance is large. Oppositely, if the handsfree function is not triggered, the range finding function of the range detection unit 106 is turned off, and the volume of the speaker 100 and the gain of the microphone 102 are set to be appropriate values for little-distance uses.

In addition, in the step 206 of the process 20, when adjusting the volume of the speaker 100 and the gain of the microphone 102, the present invention can dynamically adjust the volume of the speaker 100 and the gain of the microphone 102 in response to results of the range detection unit 106. Or, the present invention can tune up the volume and the gain to predetermined values respectively when the result of the range detection unit 106 represents that the distance between the user and the telephone 10 is larger than a predetermined distance, and tune down the volume and the gain to other values respectively when the result of the range detection unit 106 represents that the distance between the user and the telephone 10 is smaller than the predetermined distance. As a result, when using the handsfree function of the telephone 10 for making a call, the user can rapidly turn off the handsfree function to decrease the volume of the speaker 100 by decreasing the distance between the user and the telephone 10, or by picking up the telephone 10. Therefore, in case that the handsfree function of the telephone 10 is switched on for multi-user communication, the user can rapidly stop the handsfree function by picking up or approaching the telephone 10 when talking about personal affairs.

Therefore, using the range detection unit 106, the telephone 10 can determine the distance between the user and the telephone 10, so as to adjust the volume of the speaker 100 and/or the gain of the microphone 102 through the volume adjustment unit 108. Note that, the telephone 10 shown in FIG. 1 is only an exemplarily embodiment, and can be wired, wireless telephones, mobile phones, etc.

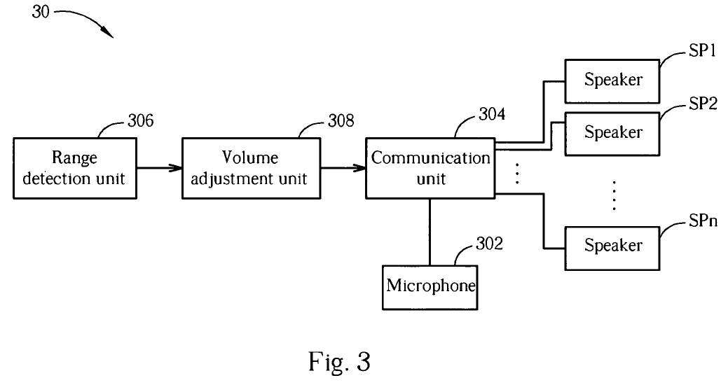

In general, a telephone includes a handset speaker having a small gain for little-distance uses and a ring speaker having a large gain for alarming an incoming phone. Therefore, the present invention further provides a telephone capable of switching speakers for outputting voice signals according to a distance between a user and the telephone. Please refer to FIG. 3, which illustrates a block diagram of a telephone 30 capable of dynamically adjusting volume in accordance with an embodiment of the present invention. The telephone 30 includes speakers SP1 to SPn, a microphone 302, a communication unit 304, a range detection unit 306, and a volume adjustment unit 308. The speakers SP1 to SPn, the microphone 102, and the range detection unit 106 are installed on a housing (not shown in FIG. 3) of the telephone 30, while the communication unit 304 and the volume adjustment unit 308 are installed inside the housing. The speakers SP1 to SPn have different power gains, so that volumes of the speakers SP1 to SPn are different. When a user answers or makes a phone call with the telephone 30, the communication unit 304 can output voice signals through one of the speakers SP1 to SPn, and receives voice signals of the user through the microphone 302. The range detection unit 306 measures a distance between the user and the telephone 30, and can be an infrared rangefinder, laser reflection rangefinder, or other devices capable of detecting the distance. According to a result of the range detection unit 306, the volume adjustment unit 308 chooses a speaker for outputting voice signal from the speakers SP1 to SPn.

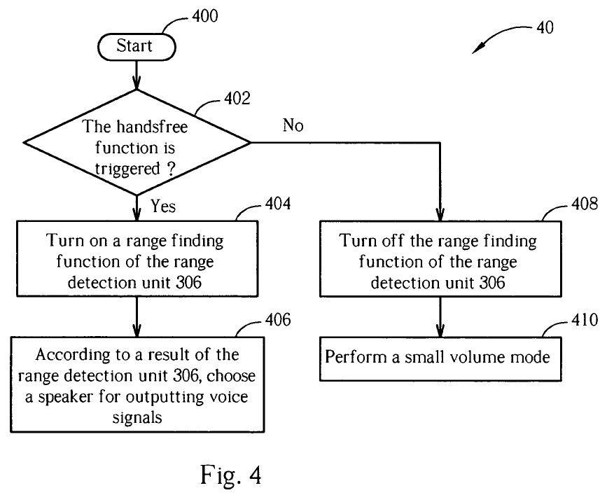

Therefore, according to the distance between the user and the telephone 30, the telephone 30 can choose an optimal speaker. As a result, when the distance is small, the telephone 30 outputs voice signals through a speaker having a small power gain, and when the distance is large, the telephone 30 outputs voice signals through a speaker having a large power gain. Certainly, functions of the range detection unit 306 and the volume adjustment unit 308 can be enabled after a handsfree function of the telephone 30 is triggered. Similarly, other than choosing the speakers according to the distance between the user and the telephone 30, the present invention can adjust a gain of the microphone 302 according to the distance. That is, the gain of the microphone 302 is small when the distance is small, and the gain is large when the distance is large. Please refer to FIG. 4, which illustrates a flowchart of a process 40 for dynamically adjusting the volume of the telephone 30. The process 40 is a preferred embodiment for choosing the speakers SP1 to SPn and/or adjusting the gain of the microphone 302, and includes following steps:
Step 400: a user answers or makes a phone call with the telephone 30.
Step 402: determine whether the handsfree function of the telephone 30 is triggered or not. If yes, go to step 404. If not, go to step 408.
Step 404: turn on a range finding function of the range detection unit 306.
Step 406: choose a speaker for outputting voice signals according to a result of the range detection unit 306.
Step 408: turn off the range finding function of the range detection unit 306.
Step 410: perform a small volume mode.

Therefore, according to the process 40, when the user answers or makes a phone call with the telephone 30 and the handsfree function is triggered, the telephone 30 can choose a speaker for outputting voice signals from the speakers SP1 to SPn and adjust the gain of the microphone 102 according to a distance between the user and the telephone 30. As a result, a speaker having low power is selected and the gain of the microphone 102 is tuned down when the distance between the user and the telephone 30 is small, while a speaker having large power is selected and the gain of the microphone 102 is tuned up when the distance is large. Oppositely, if the handsfree function is not triggered, the range finding function of the range detection unit 306 is turned off, a speaker having power for little-distance uses is selected and the gain of the microphone 102 is set to be appropriate values for little-distance uses.

When using the handsfree function of the telephone 30 for making a call, the user can rapidly turn off the handsfree function to decrease the volume of the telephone by decreasing the distance between the user and the telephone 30, or by picking up the telephone 30. Therefore, in case that the handsfree function of the telephone 30 is switched on for multi-user communication, the user can rapidly stop the handsfree function by picking up or approaching the telephone 30 when talking about personal affairs. As a result, using the range detection unit 306, the telephone 30 can determine the distance between the user and the telephone 30, so as to choose an appropriate speaker and/or adjust the gain of the microphone 302 through the volume adjustment unit 308. Note that, the telephone 30 shown in FIG. 3 is only an exemplarily embodiment, and can be wired, wireless telephones, mobile phones, etc.

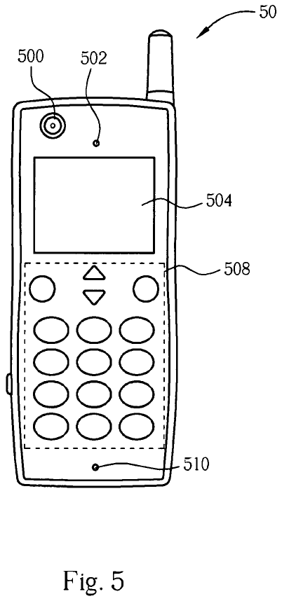

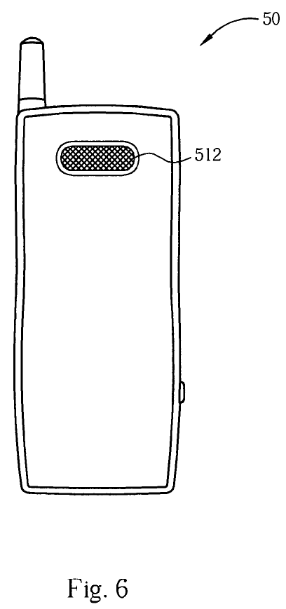

Please refer to FIG. 5 and FIG. 6. FIG. 5 illustrates a front-view diagram of a mobile phone 50 in accordance with an embodiment of the present invention, while FIG. 6 illustrates a rear-view diagram of the mobile phone 50. The mobile phone 50 includes a range detection unit 500, a handset speaker 502, a monitor 504, a keypad 508, a microphone 510, and a ring speaker 512. The monitor 504 reveals information of the mobile phone 50. A user can control operations of the mobile phone 50 through the keypad 508 to make or answer a phone call, perform a handsfree function, etc. The handset speaker 502 is for little-distance uses, and has a power gain much smaller than that of the ring speaker 512. The ring speaker 512 can output loud voice signals for alarming incoming phones. The range detection unit 500 is an infrared rangefinder for measuring a distance between the user and the mobile phone 50 after the handsfree function is triggered, and transmitting the measured result to a volume adjustment unit (not shown in FIG. 5) of the mobile phone 50. The volume adjustment unit can select a speaker for outputting voice signals from the handset speaker 502 and the ring speaker 512 according to the result of the range detection unit 500.

For example, when the user answers or makes a phone call with the telephone 50 and the handsfree function is triggered, the volume adjustment unit can select the ring speaker 512 for outputting loud voice signals if the distance between the user and the mobile phone 50 is larger than a predetermined distance, and the volume adjustment unit can select the handset speaker 502 for outputting lower voice signals if the distance between the user and the mobile phone 50 is smaller than the predetermined distance. Therefore, in case that the handsfree function of the telephone 30 is switched on for multi-user communication, the user can rapidly stop the handsfree function by picking up or approaching the telephone 50 when talking about personal affairs. Certainly, the mobile phone 50 can also adjust a gain of a microphone according to the distance between the user and the mobile phone 50, which is same as what has been mentioned above, and will not be narrated further. In addition, as the embodiment shown in FIG. 1, the mobile phone 50 can further adjust volumes of the handset speaker 502 and the ring speaker 512 according to the distance between the user and the mobile phone 50.

In summary, when using the handsfree function for a call, the embodiment of the present invention can adjust volume of the speaker or select a speaker according to the distance between the user and the telephone. Therefore, the user can rapidly turn off the handsfree function to decrease the volume of the telephone by decreasing the distance between the user and the telephone, or by picking up a transmitter of the telephone. Therefore, in case that the handsfree function of the telephone is switched on for multi-user communication, the user can rapidly stop the handsfree function by picking up or approaching the telephone when talking about personal affairs.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A mobile device capable of dynamically adjusting volume, comprising:
at least a speaker;
a range detection unit for detecting a distance between the mobile device and a user; and
a volume adjustment unit electrically connected to the range detection unit for dynamically adjusting volume of the speaker according to a result of the range detection unit.

2. The mobile device of claim 1, wherein the range detection unit is an infrared rangefinder.

3. The mobile device of claim 1, wherein the volume adjustment unit is utilized for dynamically adjusting the volume of the speaker according to the result of the range detection unit when a handsfree function of the mobile device is enabled.

4. The mobile device of claim 1, wherein the volume adjustment unit is utilized for increasing the volume of the speaker when the distance detected by the range detection unit is larger than a predetermined value, and for decreasing the volume of the speaker when the distance detected by the range detection unit is smaller than the predetermined value.

5. The mobile device of claim 1, wherein the volume adjustment unit is further utilized for adjusting a gain of a microphone according to the result of the range detection unit.

6. The mobile device of claim 5, wherein the volume adjustment unit is utilized for increasing the gain of the microphone when the distance detected by the range detection unit is larger than a predetermined value, and for decreasing the gain of the microphone when the distance detected by the range detection unit is smaller than the predetermined value.

7. A method for dynamically adjusting volume of a mobile device, comprising:
detecting a distance between the mobile device and a user; and
adjusting the volume of the mobile device dynamically according to the distance between the mobile device and the user.

8. The method of claim 7, wherein adjusting the volume of the mobile device dynamically according to the distance between the mobile device and the user is performed when a handsfree function of the mobile device is enabled.

9. The method of claim 7, wherein adjusting the volume of the mobile device dynamically according to the distance between the mobile device and the user is increasing the volume of the mobile device when the distance between the mobile device and the user is larger than a predetermined value, and decreasing the volume of the mobile device when the distance between the mobile device and the user is smaller than the predetermined value.

10. The method of claim 7, further comprising adjusting a gain of a microphone of the mobile device according to the distance between the mobile and the user.

11. The method of claim 10, wherein adjusting the gain of the microphone of the mobile device according to the distance between the mobile device and the user is performed when a handsfree function of the mobile device is enabled.

12. The method of claim 10, adjusting the gain of the microphone of the mobile device according to the distance between the mobile and the user is increasing the gain of the microphone of the mobile device when the distance between the mobile device and the user is larger than a predetermined value, and decreasing the gain of the microphone of the mobile device when the distance between the mobile device and the user is smaller than the predetermined value.
